(19) United States
(12) Patent Application Publication
(10) Pub. No.: US 2025/0190593 A1
(43) Pub. Date: Jun. 12, 2025

(54) SYSTEM AND METHOD FOR MANAGING ACCESS TO ASSET INFORMATION OF SMART FACTORY

(71) Applicant: LS ELECTRIC CO., LTD., Anyang-si, Gyeonggi-do (KR)

(72) Inventor: Seong Joon LEE, Anyang-si, Gyeonggi-do (KR)

(21) Appl. No.: 18/844,117

(22) PCT Filed: Feb. 16, 2023
(86) PCT No.: PCT/KR2023/002264

§ 371 Date: Sep. 5, 2024

(30) Foreign Application Priority Data
Apr. 18, 2022 (KR) 10-2022-0047469

(51) Int. Cl. G06F 21/60; G06F 21/62; G06Q 50/04

(52) U.S. Cl. CPC G06F 21/604; G06F 21/6218; G06Q 50/04; G06F 2221/2113

(57) ABSTRACT

The present invention disclosure relates to a system and a method for managing access to asset information of a smart factory. The system according to an embodiment of the present invention disclosure is a system for managing asset information and managing access to the asset information of a smart factory, the system comprising: a memory storing asset information; and a control unit for controlling an authorized user's access authority for asset information according to an asset status of the asset information, wherein the asset status is changed time-sequentially according to a life cycle of a product to be manufactured in a smart factory.

### CROSS-REFERENCE TO RELATED APPLICATIONS

This application is the National Stage filing under 35 U.S.C. 371 of International Application No. PCT/KR2023/002264, filed on Feb. 16, 2023, which claims the benefit of earlier filing date and right of priority to Korean Application No. 10-2022-0047469, filed on Apr. 18, 2022, the contents of which are all hereby incorporated by reference herein in their entirety.

### FIELD

The present disclosure relates to a technology for managing access to asset information of a smart factory.

### BACKGROUND

Recently, with changes in market trends that have to meet the diverse needs of consumers, the need for process technology and structure that can respond to low-volume production of a variety of products is emerging. Accordingly, a smart factory that combines a manufacturing system and an IT system to improve flexibility, adaptability, and transparency of a production process has emerged.

A technology for managing asset information of a smart factory by virtually implementing asset information based on an Asset Administration Shell or the like is applied to such a smart factory.

However, in a conventional management system for asset information of a smart factory (hereinafter referred to as a “related art”), asset information to be managed was mainly limited to asset management for factory manufacturing equipment. In addition, because the asset information was not shared with an external stakeholder (for example, a customer, a cooperative company, etc.), the related art not only did not apply a technology for managing access to the asset information by the external stakeholders, but also had the limitation of performing access management only for an internal stakeholder (for example, an administrator, a planner, a developer, a producer, an operator, etc.) through a simple function such as logging in to the asset information. Accordingly, the asset information was also implemented in a simple form that could be categorized and provided according to the authority of the internal stakeholder.

However, the above-described content merely provides background information on the present disclosure and does not correspond to a previously disclosed technology.

### SUMMARY

In order to solve the above problems of the related art, the present disclosure is directed to providing a technology for managing access to asset information of a smart factory.

That is, the present disclosure is directed to providing a technology for managing access to asset information of a smart factory by managing the asset information of the smart factory, updating a status of the asset information, and appropriately categorizing and delivering the asset information according to internal and external stakeholders accessing the asset information.

However, problems to be solved by the present disclosure are not limited to the problems mentioned above, and other problems that are not mentioned can be clearly understood by those skilled in the art to which the present disclosure belongs from the description below.

A system according to an embodiment of the present disclosure to solve the problems described above is a system for managing asset information of a smart factory and managing access to the asset information, the system including a memory that stores the asset information; and a controller that controls an access authority of an authenticated user to the asset information according to an asset status of the asset information.

The asset status may be a status in time-series.

The asset status may be a status following a lifecycle of an asset.

The controller may perform control to receive information about the asset status from a server that manages an asset.

The asset status may include plan, development, production, and maintenance, and may change in that order.

The controller may categorize the authenticated user as an internal stakeholder or an external stakeholder, and may control the access authority to the asset information according to the category of the authenticated user and the asset status.

The controller may categorize each of the internal stakeholder and the external stakeholder as multiple sub-stakeholders to be sub-categorized, and may control the access authority to the asset information according to the categorized sub-stakeholders to be sub-categorized of the authenticated user and the asset status.

The internal stakeholders to be sub-categorized may include any one of an administrator, a planner, a developer, a producer, and an operator.

The external stakeholders to be sub-categorized may include any one of a customer and a cooperative company.

The asset information may be managed based on an Asset Administration Shell (AAS).

The AAS may include multiple submodels that change depending on the asset status.

The AAS may include at least one submodel containing multiple attributes divided according to asset information authority, and the controller may categorize the authenticated user as an internal stakeholder or an external stakeholder, and may control the access authority to the asset information according to the category of the authenticated user, the asset status, and the asset information authority.

A method according to an embodiment of the present disclosure is a method for managing access to asset information performed in a system that manages the asset information of a smart factory, the method including performing authentication for a user accessing the asset information and controlling an access authority of the authenticated user to the asset information according to an asset status of the asset information, in which the asset status changes time-sequentially according to a life cycle of a product to be manufactured in the smart factory.

The controlling may include categorizing the authenticated user as an internal stakeholder or an external stakeholder and controlling the access authority to the asset information according to the category of the authenticated user and the asset status.

The controlling may include categorizing each of the internal stakeholder and the external stakeholder into multiple sub-stakeholders to be sub-categorized and controlling the access authority to the asset information according to the categorized sub-stakeholders to be sub-categorized of the authenticated user and the asset status.

The asset information may be managed based on an Asset Administration Shell (AAS), the AAS may include at least one submodel containing multiple attributes divided according to asset information authority, and the controlling may include categorizing the authenticated user as an internal stakeholder or an external stakeholder and controlling the access authority to the asset information according to the category of the authenticated user, the asset status, and the asset information authority.

The present disclosure configured as described above has an advantage of being able to more easily and accurately manage access to asset information of a smart factory.

In addition, the present disclosure has an advantage that, by controlling an access authority to asset information of a smart factory according to the category of an authenticated user, current asset status, and asset information authority categorized based on an asset administration shell, the access authority to the asset information of the smart factory can be managed in detail and the asset information can be appropriately categorized and delivered according to internal and external stakeholders accessing the asset information.

In addition, the present disclosure has an advantage that, by automatically combining asset status and asset information authority to automatically determine information that can be provided according to a requester's authority, through an asset administration shell when providing the asset information, unintentional distribution of sensitive information can be prevented in advance.

The effects that can be obtained from the present disclosure are not limited to the effects mentioned above, and other effects that are not mentioned will be clearly understood by those skilled in the art to which the present disclosure belongs from the description below.

### BRIEF DESCRIPTION OF THE DRAWINGS

FIG. 1 shows a conceptual diagram of a system (100) according to an embodiment of the present disclosure.

FIG. 2 shows a block diagram of the system (100) according to the embodiment of the present disclosure.

FIG. 3 shows a block diagram of a controller (150) of the system (100) according to the embodiment of the present disclosure.

FIG. 4 shows an operational flowchart of a method according to an embodiment of the present disclosure.

FIG. 5 shows an example of the asset administration shell used in the present disclosure.

### DETAILED DESCRIPTION

The above objects and means of the present disclosure and the effects thereof will become clearer through the following detailed description in conjunction with the accompanying drawings, and accordingly, those skilled in the art to which the present disclosure belongs will be able to easily implement the technical idea of the present disclosure. In addition, in describing the present disclosure, if it is determined that a detailed description of known technologies related to the present disclosure may unnecessarily obscure the gist of the present disclosure, the detailed description thereof will be omitted.

The terms used in this specification are for describing embodiments and are not intended to limit the present disclosure. In this specification, singular forms also include plural forms in some cases unless specifically stated otherwise in the context. In this specification, terms such as “including,” “comprising.” “preparing,” and “having” do not exclude the presence or addition of one or more components other than those mentioned.

In this specification, terms such as “or,” “at least one,” and the like may represent one of words listed together, or represent a combination of two or more words. For example, “A or B” and “at least one of A and B” may include only one of A and B, or may include both A and B.

In this specification, descriptions following “for example,” or the like may not exactly match the information presented, such as the characteristics, variables, or values cited, and should not limit the embodiments of the disclosure according to various examples of the present disclosure due to effects such as variations, including tolerances, measurement errors, limits of measurement accuracy, and other factors that are commonly known.

In this specification, when a component is described as being “coupled” or “connected” to another component, it should be understood that it may be directly coupled or connected to the other component, or there may be other components in between. On the other hand, when a component is mentioned as being “directly coupled” or “directly connected” to another component, it should be understood that there are no other components in between.

In this specification, when a component is described as being “on top of” or “in contact with” another component, it should be understood that it may be in direct contact with or coupled to the other component, or there may be another component in between. On the other hand, when a component is described as being “directly on top of” or “in direct contact with” another component, it may be understood that there is no other component in between. Other expressions describing a relationship between components, such as “between” and “directly between,” may be interpreted similarly.

In this specification, terms such as “first” and “second” may be used to describe various components, but these components should not be limited by the above terms. In addition, the above terms should not be interpreted as limiting the order of each component, but may be used for the purpose of distinguishing one component from another component. For example, a “first component” may be named a “second component,” and similarly, a “second component” may also be named a “first component.”

Unless otherwise defined, all terms used in this specification may be used with meanings that can be commonly understood by those skilled in the art to which the present disclosure belongs. In addition, terms defined in commonly used dictionaries are not to be interpreted ideally or excessively unless clearly specifically defined.

Hereinafter, preferred embodiments of the present disclosure will be described in detail with reference to the accompanying drawings.

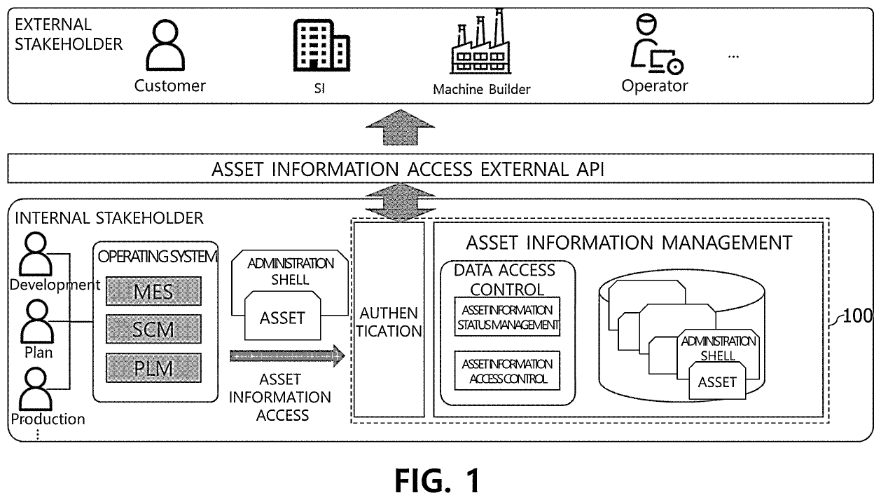

FIG. 1 shows a conceptual diagram of a system 100 according to an embodiment of the present disclosure.

The system 100 according to the embodiment of the present disclosure (hereinafter referred to as “this system”) is a system connected to a smart factory, and may be a system for managing asset information of the smart factory and managing access to the asset information (that is, an asset management system).

In this case, the asset information is information about assets within the smart factory (lines and machines for manufacturing products within the smart factory, products, product-related documents, S/W, manufacturing processes, etc.). In order to operate the smart factory, asset information needs to be shared with internal and external stakeholders while the asset information is managed.

To this end, this system 100 manages the asset information of the smart factory, updates a status of the asset information (that is, an asset status), and appropriately categorizes the asset information according to a degree of interest of a terminal or system of an internal or external stakeholder that has been authenticated through an authorization process and delivers the asset information to the terminal or system of the internal or external stakeholder among terminals or systems of various stakeholders that access the asset information.

That is, this system 100 authenticates the terminal or system of the stakeholder accessing asset information, and prior to providing the asset information to the terminal or system of the authenticated internal or external stakeholder (hereinafter referred to as “user”), selects the asset information that can be disclosed according to a current asset status. In addition, when the terminal or system of the user requests asset information, this system 100 can manage an access authority to the asset information by distributing the asset information only to the terminal or system of the stakeholder to which distribution is determined to be possible according to the authority thereof, and not distributing the asset information to any terminal or system other than the terminal or system of the stakeholder.

In this case, the system 100 may automatically determine the access authority to the asset information by linking the asset status and the asset information authority. Accordingly, the asset information can be prevented from being modified by an unauthorized stakeholder or distributed to an unauthorized stakeholder.

For access management for such asset information, the system 100 may be implemented as an electronic device capable of computing.

For example, the electronic device may be a general-purpose computing device such as a desktop personal computer (PC), a laptop personal computer (PC), a tablet personal computer (PC), a netbook computer, a workstation, etc., and may be a dedicated embedded system implemented based on Embedded Linux, or the like.

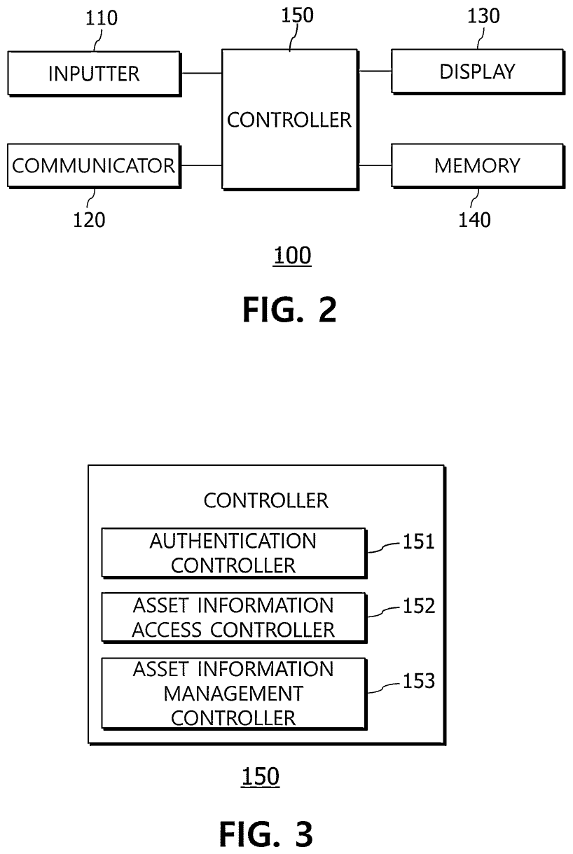

FIG. 2 shows a block diagram of the system 100 according to an embodiment of the present disclosure.

Referring to FIG. 2, the system 100 may include an inputter 110, a communicator 120, a display 130, a memory 140, and a controller 150.

The inputter 110 generates input data in response to various user inputs, and may include various input means.

For example, the inputter 110 may include, but is not limited to, a keyboard, a key pad, a dome switch, a touch panel, a touch key, a touch pad, a mouse, a menu button, etc.

The communicator 120 is a component that performs communication with other devices. For example, the communicator 120 may receive various types of data related to statuses of various facilities from various facilities in the smart factory. In addition, the communicator 120 may transmit the asset information categorized according to the degree of interest of a terminal or system used by an authenticated internal or external stakeholder accessing the asset information to the terminal or system used by the authorized internal or external stakeholder.

For example, the communicator 120 may perform wireless communication such as 5th generation communication (5G), long term evolution-advanced (LTE-A), LTE, Bluetooth, Bluetooth low energy (BLE), near field communication (NFC), or WiFi communication, or may perform wired communication such as cable communication, but is not limited thereto.

The display 130 is a component that displays various types of image data on a screen. For example, the display 130 may display asset information, and the like, and may be configured with a non-emissive panel or an emissive panel. That is, the display 130 may display various types of image data according to a control operation of the controller 150.

For example, the display 130 may include, but is not limited to, a liquid crystal display (LCD): a light emitting diode (LED) display, an organic LED (OLED) display, a micro electro mechanical systems (MEMS) display, or an electronic paper display. In addition, the display 130 may be combined with INPUTTERs 120 and 220 and implemented as a touch screen or the like.

The memory 140 stores various types of information required for the operation of the system 100. For example, information stored in the memory 140 may include, but is not limited to, asset information, asset statuses, information about an asset administration shell, information transmitted to and received from other devices through the communicator 120, information for a control operation of the controller 150, and program information related to a method to be described below.

For example, the memory 140 may include, but is not limited to, a hard disk type, a magnetic media type, a compact disc read only memory (CD-ROM) type, an optical media type, a magneto-optical media type, a multimedia card micro type, a flash memory type, a read only memory, or a random access memory type, depending on its type. In addition, the memory 140 may be a cache, a buffer, a main memory, or an auxiliary memory, or a separately provided storage system depending on its use/location, but is not limited thereto.

The controller 150 may perform various control operations of the system 100. That is, the controller 150 may control the execution of a method to be described below. In addition, the controller 150 may control the operations of the remaining components of the system 100, such as the inputter 110, the communicator 120, the display 130, and the memory 140. For example, the controller 150 may include a processor which is hardware or a process which is software executed on the processor, but is not limited thereto.

FIG. 3 shows a block diagram of the controller 150 of the system 100 according to an embodiment of the present disclosure.

Referring to FIG. 3, in order to perform an asset management operation, the controller 150 may include an authentication controller 151, an asset information access controller 152, and an asset information management controller 153. For example, the authentication controller 151, the asset information access controller 152, and the asset information management controller 153 may be hardware components of the controller 150 or software processes that are performed in the controller 150, but are not limited thereto.

Hereinafter, a method according to an embodiment of the present disclosure will be described.

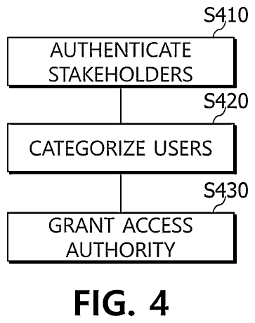

FIG. 4 shows an operational flowchart of a method according to an embodiment of the present disclosure.

The method according to the embodiment of the present disclosure (hereinafter referred to as “the present method”) is a method for managing access to asset information of a smart factory, and may include operations S410 to S430, as shown in FIG. 4.

First, in S410, an internal or external stakeholder requests access to the asset information in order to utilize the assets of the smart factory for an individual purpose, and the authentication controller 151 controls authentication for the terminal or system of the stakeholder accessing asset information. Accordingly, only registered internal or external stakeholders previously stored in the memory 140 are authenticated and permitted to access the asset information.

For example, the authentication controller 151 may use various authentication methods, such as an authentication method using sessions and cookies, an authentication method using an Access Token, an authentication method using an Access Token and a Refresh Token, and an authentication method using OAuth protocol, in addition to a simple authentication method using a pre-registered ID and password.

After that, in S420, the authentication controller 151 or the asset information access controller 152 categorizes the authenticated internal/external stakeholders (that is, users). Depending on these categories, users may have various authorities, and information about these categories and authorities may be previously stored in the memory 140. For example, each of the authenticated internal stakeholders may be categorized as a stakeholder related to an administrator, a planner, a developer, a producer, or an operator. In addition, each of the authenticated external stakeholders may be categorized as a stakeholder related to a customer or a cooperative company.

After that, in S430, the asset information access controller 152 grants an access authority to the terminal or system of the authorized internal/external stakeholder (that is, user) according to the category of the user and the asset status of the smart factory. For example, the access authority may be divided into three types of RO, R/W, and X. That is, for the asset information, there may be an access authority of read only RO, an access authority of both read and write R/W, or an access authority of neither read nor write X.

In this case, the asset status is a status related to a lifecycle of an asset of the smart factory, and is a status that changes time-sequentially according to a manufacturing process sequence of a product. For example, the asset includes the product to be manufactured in the smart factory or a manufacturing facility in the smart factory for manufacturing the product. Accordingly, the asset status may include a first status that is a status in time-series related to the life cycle of the product, a second status that is a status in time-series related to the life cycle of the manufacturing facility, or may include the first status and the second status.

For example, in the case of a smart factory where the product to be manufactured is a refrigerator, the asset status may include the first status related to the life cycle of the refrigerator or the second status related to the life cycle of a robot arm, which is a manufacturing facility for the refrigerator.

However, while the following description will be based on the asset status, which is the first status, for convenience of description, the present disclosure is not limited thereto, and the description applies equally to the asset status including the second status.

That is, the asset information management controller 153 may update the asset status according to the current status of the smart factory. For example, the asset statuses include plan, development, production, and maintenance, and each of these statuses may change sequentially over time.

In addition, the asset information management controller 153 may perform control to receive information about the current asset status from a server that manages the assets of the smart factory, such as an enterprise resource plan (ERP).

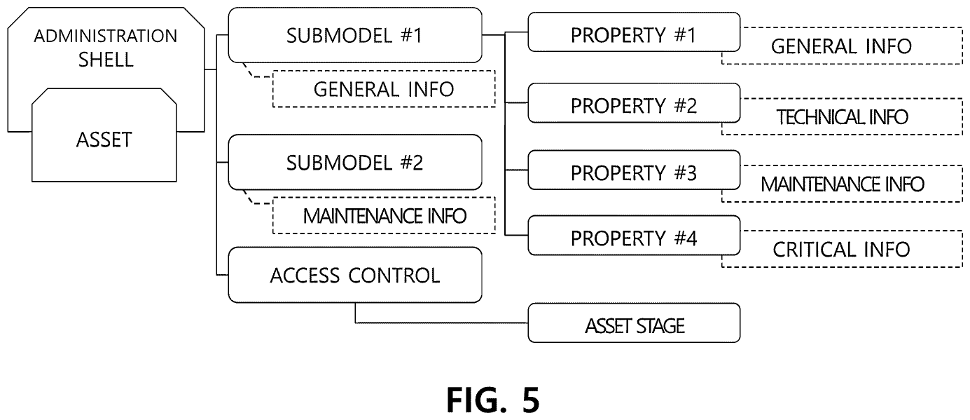

FIG. 5 shows an example of the asset administration shell used in the present disclosure.

In particular, as shown in FIG. 5, in the present disclosure, the asset information may be managed based on the asset administration shell (AAS). That is, the asset information management controller 153 may manage the assets of the smart factory to be expressed as standardized asset information through the AAS. In this case, the AAS may include multiple submodels, and each submodel may include components having multiple attributes categorized according to asset information authority.

In particular, the AAS includes various submodels that change depending on the asset status and components of those submodels. That is, the AAS may include a submodel to indicate whether the current asset information is information on a status in which the asset is being planned, information on a status in which the asset is being developed, information on a status in which the asset is being produced, or information on a status in which the asset is being operated, and components of the submodel.

For example, the AAS may include Submodel #1, which is accessible to all authenticated stakeholders (that is, users), and Submodel #2, which is accessible only to specific stakeholders. In this case, Submodel #1 may include components for asset information authority having four attributes of General Info, Technical Info, Maintenance Info, and Critical Info.

In this case, General Info represents asset information of an attribute that is accessible to anyone, and is accessible to all users. Technical Info represents asset information of an attribute related to product manufacturing, and is not accessible to a developer, but is accessible to a producer. Maintenance Info represents asset information of an attribute required for maintenance. Critical Info represents asset information of a critical attribute and is accessible only to a small number of stakeholders.

That is, the asset information access controller 152 controls an access authority to the asset information expressed based on the AAS, according to the category of the authenticated user (for example, administrator, planner, developer, producer, operator, customer, or cooperative company) and the current asset status (for example, plan, development, production, or maintenance).

In particular, the asset information access controller 152 may control the access authority to the asset information according to the category of the authenticated user (for example, an administrator, a planner, a developer, a producer, an operator, a customer, or a cooperative company), the current asset status (for example, plan, development, production, or maintenance), and the asset information authority expressed based on the AAS (General Info, Technical Info, Maintenance Info, Critical Info).

Examples of control of the access authority to the asset information according to the category of the authenticated user (access subject), the asset status, and the asset information authority of the AAS are shown in Table 1 below.

TABLE 11

| | | Asset | | | | |
|---|---|---|---|---|---|---|
| | | information | Asset status (Lifecycle) | | | |
| Access subject category | | authority | Plan | Development | Production | Maintenance |
| Internal | Administrator | General | R/W | R/W | R/W | R/W |
| stakeholder | | Technical | R/W | R/W | R/W | R/W |
| | | Maintenance | R/W | R/W | R/W | R/W |
| | | Critical | R/W | R/W | R/W | R/W |
| | Planner | General | R/W | R/W | RO | RO |
| | | Technical | R/W | RO | RO | RO |
| | | Maintenance | R/W | RO | X | X |
| | | Critical | X | X | X | X |
| | Developer | General | RO | RO | RO | RO |
| | | Technical | RO | R/W | RO | RO |
| | | Maintenance | X | RO | X | X |
| | | Critical | X | X | X | X |
| | Producer | General | X | X | R/W | RO |
| | | Technical | X | X | RO | X |
| | | Maintenance | X | X | RO | RO |
| | | Critical | X | X | X | X |
| | Operator | General | X | X | RO | R/W |
| | | Technical | X | X | RO | RO |
| | | Maintenance | X | X | RO | R/W |
| | | Critical | X | X | X | X |
| External | Customer | General | X | X | RO | X |
| stakeholder | | Technical | X | X | X | X |
| | | Maintenance | X | X | X | X |
| | | Critical | X | X | X | X |
| | Cooperative | General | X | RO | RO | X |
| | company | Technical | X | RO | RO | X |
| | | Maintenance | X | X | X | X |
| | | Critical | X | X | X | X |

In Table 1, RO indicates that the asset information can only be read, R/W indicates that the asset information can be read and written, and X indicates that the asset information can be neither read nor written.

For example, a terminal or system of an administrator (one of the authenticated internal stakeholders) is allowed to perform an operation of R/W for asset information having attributes of all asset information authorities of General Info, Technical Info, Maintenance Info, and Critical Info in all asset statuses of plan, development, production, and maintenance. A terminal or system of a planner (one of the authenticated internal stakeholders) is allowed to perform an operation of R/W or RO for asset information having the attributes of the asset information authorities of General Info and Technical Info in all asset statuses of plan, development, production, and maintenance, is allowed to perform the operation of R/W or RO for asset information having the attribute of the asset information authority of Maintenance Info only in the asset statuses of plan and development, is not allowed to perform the operation of R/W or RO in the asset statuses of production and maintenance, and is not allowed to perform the operations of R/W or RO for asset information having the attribute of the asset information authority of Critical Info in all asset statues of plan, development, production, and maintenance.

A terminal or system of a developer (one of the authenticated internal stakeholders) is allowed to perform the operation of R/W or RO for asset information having the attributes of the asset information authorities of General Info and Technical Info in all asset statuses of plan, development, production, and maintenance, is allowed to perform the operation of RO for asset information having the attribute of the asset information authority of Maintenance Info only in the asset status of development, and is not allowed to perform the operation of R/W or RO for asset information having the attribute of the asset information authority of Critical Info in all asset statuses of plan, development, production, and maintenance.

A terminal or system of a producer (one of the authenticated internal stakeholders) is allowed to perform the operation of R/W or RO for asset information having the attributes of the asset information authorities of General Info and Maintenance Info only in the asset statuses of production and maintenance, is allowed to perform the operation of RO for asset information having the asset information authority of Technical Info only in the asset status of production, and is not allowed to perform the operations of R/W or RO for asset information having the attribute of the asset information authority of Critical Info in all asset statuses of plan, development, production, and maintenance.

A terminal or system of an administrator (one of the authenticated internal stakeholders) is allowed to perform the operation of R/W or RO for asset information having the attributes of the asset information authorities of General Info, Technical Info, and Maintenance Info only in the asset statuses of production and maintenance, and is not allowed to perform the operation of R/W or RO for asset information having the attribute of the asset information authority of Critical Info in all asset statuses of plan, development, production, and maintenance.

That is, only the administrator among the authorized internal stakeholders can access the asset information having the attribute of the asset information authority of Critical Info.

Meanwhile, a terminal or system of a customer (one of the authenticated external stakeholders) is allowed to perform the operation of RO for asset information having the attribute of the asset information authority of General Info only in the asset status of production, and is allowed to perform the operations of both R/W and RO in the rest of the asset statuses.

A terminal or system of a cooperative company (one of the authenticated external stakeholders) is allowed to perform the operation of RO for asset information having the attributes of the asset information authorities of General Info and Technical Info only in the asset statuses of development and production, and is allowed to perform the operations of both R/W and RO in the rest of the asset statuses.

The present disclosure configured as described above has an advantage of being able to more easily and accurately manage access to asset information of a smart factory. In addition, the present disclosure has an advantage that, by controlling an access authority to asset information of the smart factory according to the category of the authenticated user, current asset status, and asset information authority categorized based on the AAS, the access authority to the asset information of the smart factory can be managed in detail and the asset information can be appropriately categorized and delivered according to internal and external stakeholders accessing the asset information. In addition, the present disclosure has an advantage that, by automatically combining asset status and asset information authority to automatically determine information that can be provided according to a requester's authority, through the AAS when providing the asset information, unintentional distribution of sensitive information can be prevented in advance.

Although specific embodiments have been described in the detailed description of the present disclosure, various modifications may also be made thereto without departing from the scope of the present disclosure. Therefore, the scope of the present disclosure is not limited to the described embodiments, but is to be defined by the claims described below and their equivalents.

### INDUSTRIAL APPLICABILITY

Since the present disclosure relates to a system and a method for managing access to asset information of a smart factory, and can provide a system and a method for managing access to the asset information of a smart factory that involve managing the asset information of the smart factory, updating a status of the asset information, and appropriately categorizing and delivering the asset information according to internal and external stakeholders accessing the asset information, the present disclosure has industrial applicability.

1. A system for managing asset information of a smart factory and managing access to the asset information, the system comprising:
a memory that stores the asset information; and
a controller that controls an access authority of an authenticated user to the asset information according to an asset status of the asset information.

2. The system of claim 1, wherein the asset status is a status in time-series.

3. The system of claim 1, wherein the asset status is a status following a lifecycle of an asset.

4. The system of claim 1, wherein the controller performs control to receive information about the asset status from a server that manages an asset.

5. The system of claim 1, wherein the asset status includes plan,
development, production, and maintenance, and changes in that order.

6. The system of claim 1, wherein the controller categorizes the authenticated user as an internal stakeholder or an external stakeholder, and controls the access authority to the asset information according to the category of the authenticated user and the asset status.

7. The system of claim 5, wherein the controller categorizes each of an internal stakeholder and an external stakeholder as multiple sub-stakeholders to be sub-categorized, and controls the access authority to the asset information according to the categorized sub-stakeholders to be sub-categorized of the authenticated user and the asset status.

8. The system of claim 7, wherein the internal stakeholders to be sub-categorized include any one of an administrator, a planner, a developer, a producer, and an operator.

9. The system of claim 7, wherein the external stakeholders to be sub-categorized include any one of a customer and a cooperative company.

10. The system of claim 1, wherein the asset information is managed based on an Asset Administration Shell (AAS).

11. The system of claim 10, wherein the AAS includes multiple submodels that change depending on the asset status.

12. The system of claim 10, wherein the AAS includes at least one submodel containing multiple attributes divided according to asset information authority, and
the controller categorizes the authenticated user as an internal stakeholder or an external stakeholder and controls the access authority to the asset information according to the category of the authenticated user, the asset status, and the asset information authority.

13. A method for managing access to asset information performed in a system that manages the asset information of a smart factory, the method comprising:
performing authentication for a user accessing the asset information; and
controlling an access authority of the authenticated user to the asset information according to an asset status of the asset information.

14. The method of claim 13, wherein the asset status is a status in time-series according to a life cycle of an asset.

15. The method of claim 13, wherein the asset status includes plan, development, production, and maintenance, and changes in that order.

16. The method of claim 13, further comprising:
receiving information about the asset status from a server that manages an asset.

17. The method of claim 13, wherein the asset status includes plan, development, production, and maintenance, and changes in that order.

18. The method of claim 13, wherein the controlling includes categorizing the authenticated user as an internal stakeholder or an external stakeholder and controlling the access authority to the asset information according to the category of the authenticated user and the asset status.

19. The method of claim 18, wherein the controlling includes categorizing each of the internal stakeholder and the external stakeholder into multiple sub-stakeholders to be sub-categorized and controlling the access authority to the asset information according to the categorized sub-stakeholders to be sub-categorized of the authenticated user and the asset status.

20. The method of claim 13, wherein the asset information is managed based on an Asset Administration Shell (AAS),
the AAS includes at least one submodel containing multiple attributes divided according to asset information authority, and
the controlling incudes categorizing the authenticated user as an internal stakeholder or an external stakeholder and controlling the access authority to the asset information according to the category of the authenticated user, the asset status, and the asset information authority.
